(19) United States
(12) Patent Application Publication
(10) Pub. No.: US 2024/0271995 A1
(43) Pub. Date: Aug. 15, 2024

(54) MEASURING INSTRUMENT WITH BUILT-IN CALIBRATION DATA

(71) Applicants: Yokogawa Electric Corporation, Tokyo (JP); Yokogawa Test & Measurement Corporation, Tokyo (JP)

(72) Inventor: Kouichi Kataoka, Tokyo (JP)

(21) Appl. No.: 18/405,386

(22) Filed: Jan. 5, 2024

(30) Foreign Application Priority Data
Feb. 14, 2023 (JP) 2023-021171

(51) Int. Cl. G01J 1/02; G01J 1/42

(52) U.S. Cl. CPC G01J 1/0295; G01J 1/42

(57) ABSTRACT

A measuring instrument with built-in calibration data is capable of traceable measurement. The measuring instrument with built-in calibration data includes a sensor, a calibration data manager storing calibration data of the measuring instrument with built-in calibration data, a setting data manager storing a setting condition of the measuring instrument with built-in calibration data, a memory capable of storing a measurement value measured by the sensor, and a traceability determiner. The calibration data includes calibration results and calibration conditions, the calibration results indicating a difference in measurement results from a higher-level standard. Each calibration result is associated with the calibration condition at the time at which the calibration result was acquired. The traceability determiner compares the setting condition and the measurement value to the calibration conditions, calculates, in a case in which there exists a calibration condition that matches the setting condition and the measurement value, a calibrated measurement value by correcting the measurement value with the calibration result associated with the calibration condition, and stores the calculated calibrated measurement value in the memory.

### CROSS-REFERENCE TO RELATED APPLICATION

The present application claims priority to Japanese Patent Application No. 2023-021171 filed on Feb. 14, 2023, the entire contents of which are incorporated herein by reference.

### TECHNICAL FIELD

The present disclosure relates to a measuring instrument with built-in calibration data.

### BACKGROUND

Some conventional measuring instruments are linked to national standards. Such measuring instruments are also referred to as traceable measuring instruments.

Usually, the measurement values of such traceable measuring instruments are calibrated by a higher-level standard. The higher-level standard is calibrated by a higher-level standard at an even higher level. In this way, the traceable measuring instruments can ultimately be traced back to a national standard. Traceable measuring instruments are thus linked to national standards.

For example, Patent Literature (PTL) 1 discloses a calibration apparatus for optical power meters that can calibrate measurement values using an optical power measurement standard.

### CITATION LIST

### Patent Literature

PTL 1: Utility Model Application Publication No. H02-150529

### SUMMARY

A measuring instrument with built-in calibration data according to one of several embodiments is capable of traceable measurement and includes:
a sensor;
a calibration data manager configured to store calibration data of the measuring instrument with built-in calibration data;
a setting data manager configured to store a setting condition of the measuring instrument with built-in calibration data;
a memory capable of storing a measurement value measured by the sensor; and
a traceability determiner, wherein
the calibration data includes a plurality of calibration results and a plurality of calibration conditions, the calibration results indicating a difference in measurement results from a higher-level standard,
each calibration result is associated with the calibration condition corresponding to a time at which the calibration result was acquired, and
the traceability determiner is configured to
   compare the setting condition and the measurement value to the plurality of calibration conditions,
   in a case in which there exists a matching calibration condition, among the plurality of calibration conditions, that matches the setting condition and the measurement value, calculate a calibrated measurement value by correcting the measurement value with the calibration result associated with the matching calibration condition, and
   store the calibrated measurement value in the memory.

### BRIEF DESCRIPTION OF THE DRAWINGS

In the accompanying drawings:

FIG. 1 is a diagram illustrating a schematic configuration of a measuring instrument with built-in calibration data according to an embodiment;

FIG. 2 is a flowchart illustrating operations of the measuring instrument with built-in calibration data according to an embodiment; and

FIG. 3 is a diagram illustrating a schematic configuration of a measuring instrument according to a comparative example.

### DETAILED DESCRIPTION

Conventionally, when a measurement value that is measured by a measuring instrument is calibrated by a higher-level standard, the user often manually calibrates the measurement value using calibration data that includes information on the difference in the measurement value compared to the higher-level standard when the same object is measured.

Manually calibrating measurement values in this way places a large burden on the user.

It could be helpful to provide a measuring instrument with built-in calibration data that can facilitate calibration of measurement values.

A measuring instrument with built-in calibration data according to one of several embodiments is capable of traceable measurement and includes: a sensor; a calibration data manager configured to store calibration data of the measuring instrument with built-in calibration data; a setting data manager configured to store a setting condition of the measuring instrument with built-in calibration data; a memory capable of storing a measurement value measured by the sensor; and a traceability determiner, wherein the calibration data includes a plurality of calibration results and a plurality of calibration conditions, the calibration results indicating a difference in measurement results from a higher-level standard, each calibration result is associated with the calibration condition corresponding to a time at which the calibration result was acquired, and the traceability determiner is configured to compare the setting condition and the measurement value to the plurality of calibration conditions, calculate, in a case in which there exists a matching calibration condition, among the plurality of calibration conditions, that matches the setting condition and the measurement value, a calibrated measurement value by correcting the measurement value with the calibration result associated with the matching calibration condition, and store the calculated calibrated measurement value in the memory. According to such a measuring instrument with built-in calibration data, the calibration of measurement values can be facilitated.

In the measuring instrument with built-in calibration data according to an embodiment, in a case in which no calibration condition matches the setting condition and the measurement value, the traceability determiner may be configured to store the measurement value measured by the sensor as is in the memory as an uncalibrated measurement value. With this configuration, the uncalibrated measurement value can be stored in the memory as is when the calibrated measurement value cannot be calculated.

The measuring instrument with built-in calibration data according to an embodiment further comprises a display, and the traceability determiner may be configured to display, on the display, the calibrated measurement value or the uncalibrated measurement value. With this configuration, the user can confirm the calibrated measurement value or the uncalibrated measurement value.

In the measuring instrument with built-in calibration data according to an embodiment, in a case in which the calibrated measurement value is calculated, the traceability determiner may be configured to display, on the display, the calibrated measurement value together with a notation indicating that the calibrated measurement value is a traceable value. With this configuration, the user can know that the value displayed on the display is a traceable value.

In the measuring instrument with built-in calibration data according to an embodiment, the calibration data may further include information on a date and time at which the plurality of calibration results was acquired, and in a case in which a current date and time exceeds a date and time yielded by adding a recommended calibration period to the date and time at which the plurality of calibration results was acquired, the traceability determiner may be configured to display an alarm on the display. With this configuration, the user can recognize that new calibration data needs to be stored in the calibration data manager.

In the measuring instrument with built-in calibration data according to an embodiment, the calibration data may further include information on a date and time at which the plurality of calibration results was acquired, and in a case in which a current date and time exceeds a date and time yielded by adding a recommended calibration period to the date and time at which the plurality of calibration results was acquired, the traceability determiner may be configured to refrain from displaying, on the display, the notation indicating that the calibrated measurement value is a traceable value even in a case in which the calibrated measurement value is calculated. With this configuration, the user can be prevented from using, as a traceable value, a measurement value calibrated by a calibration result that is past the recommended calibration period.

In the measuring instrument with built-in calibration data according to an embodiment, the calibration data manager may be configured to store a plurality of sets of calibration data linked to national standards of a plurality of countries, and the traceability determiner may be configured to calculate the calibrated measurement value using calibration data selected by a user from among the plurality of sets of calibration data. With this configuration, the user can calibrate the measurement value using the calibration data linked to the national standard of a desired country.

In the measuring instrument with built-in calibration data according to an embodiment, the measuring instrument with built-in calibration data may be an optical power meter.

In the measuring instrument with built-in calibration data according to an embodiment, the setting condition and the calibration condition may include a wavelength of light as an item.

According to the present disclosure, a measuring instrument with built-in calibration data that can facilitate calibration of measurement values can be provided.

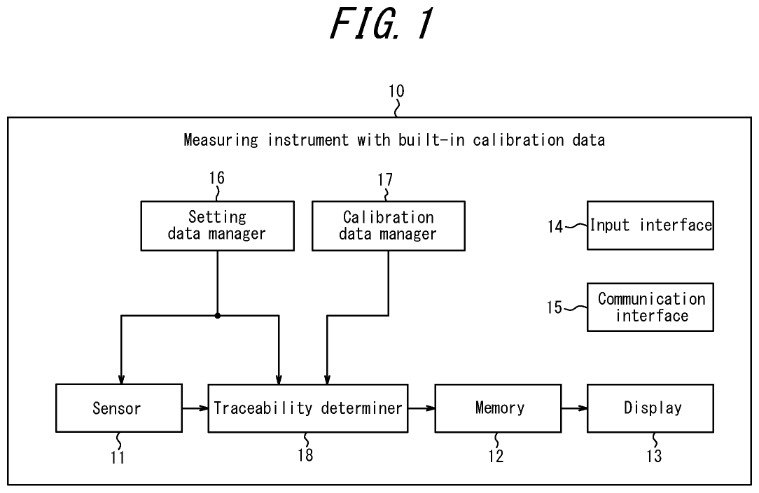

FIG. 1 is a diagram illustrating a schematic configuration of a measuring instrument with built-in calibration data 10 according to an embodiment. Referring to FIG. 1, the configuration and functions of the measuring instrument with built-in calibration data 10 according to an embodiment are described.

The measuring instrument with built-in calibration data 10 includes a sensor 11, a memory 12, a display 13, an input interface 14, a communication interface 15, a setting data manager 16, a calibration data manager 17, and a traceability determiner 18.

The measuring instrument with built-in calibration data 10 is capable of traceable measurement. That is, the measuring instrument with built-in calibration data 10 can be calibrated by a higher-level standard and can be linked to a national standard by tracing back the higher-level standard.

The measuring instrument with built-in calibration data 10 may, for example, be an optical power meter. In the present embodiment, the case in which the measuring instrument with built-in calibration data 10 is an optical power meter is described, but this is only an example. The measuring instrument with built-in calibration data 10 may be a measuring instrument other than an optical power meter.

The sensor 11 is a sensor that measures a physical quantity to be measured. In a case in which the measuring instrument with built-in calibration data 10 is an optical power meter, the sensor 11 measures optical power. In a case in which the sensor 11 is a sensor that measures optical power, the sensor 11 may use any method capable of measuring optical power.

The memory 12 is, for example, a semiconductor memory, a magnetic memory, an optical memory, or the like, but is not limited to these. The memory 12 may, for example, function as a main memory, an auxiliary memory, or a cache memory. The memory 12 stores any information used for operations of the measuring instrument with built-in calibration data 10. For example, the memory 12 may store a system program, an application program, various types of data, and the like.

The memory 12 can store the measurement values measured by the sensor 11. The memory 12 can also store the calibrated measurement values calculated by correcting the measurement values. The calculation of the calibrated measurement values is described below.

The display 13 includes one or more interfaces for output that display information. The display 13 may, for example, include a liquid crystal display (LCD), an organic electro luminescence (EL) display, or the like.

The display 13 can display the measurement values measured by the sensor 11. The display 13 can also display the calibrated measurement values calculated by correcting the measurement values.

The input interface 14 includes one or more interfaces for input to acquire input information based on user operations. For example, the input interface 14 may include buttons and the like. The input interface 14 may be integrated with the display 13 and configured as a touchscreen.

The input interface 14 can acquire the setting conditions of the measuring instrument with built-in calibration data 10 by user operation when the user performs a measurement using the measuring instrument with built-in calibration data 10. For example, in a case in which the measuring instrument with built-in calibration data 10 is an optical power meter, the setting conditions may include the wavelength of light, the measurement range, and the like as items.

The communication interface 15 includes at least one of a communication module compatible with wired communication and a communication module compatible with wireless communication. The measuring instrument with built-in calibration data 10 can communicate with other apparatuses via the communication interface 15.

The setting data manager 16 is, for example, a semiconductor memory, a magnetic memory, an optical memory, or the like, but is not limited to these.

The setting data manager 16 stores the setting conditions of the measuring instrument with built-in calibration data 10 when the user performs a measurement using the measuring instrument with built-in calibration data 10. Upon the input interface 14 acquiring the setting conditions of the measuring instrument with built-in calibration data 10 when the user performs a measurement using the measuring instrument with built-in calibration data 10, the setting data manager 16 stores the acquired setting conditions. The sensor 11 is set to the setting conditions stored in the setting data manager 16.

The calibration data manager 17 is, for example, a semiconductor memory, a magnetic memory, an optical memory, or the like, but is not limited to these.

The calibration data manager 17 stores calibration data. Calibration data is data for using the higher-level standard of the measuring instrument with built-in calibration data 10 to calibrate the measurement values measured by the measuring instrument with built-in calibration data 10. The higher-level standard can be calibrated by its own higher-level standard, which can ultimately be traced back to a national standard.

The calibration data includes a plurality of calibration results and a plurality of calibration conditions. The calibration results indicate the difference between the measurement results of the measuring instrument with built-in calibration data 10 and the measurement results of the higher-level standard when the same object was measured. The calibration conditions include information on the setting conditions and information on the measurement conditions for the measuring instrument with built-in calibration data 10 when the calibration results were acquired. For example, in a case in which the measuring instrument with built-in calibration data 10 is an optical power meter, the calibration conditions may include the wavelength of light and the like as items of the setting conditions. The calibration conditions may also include input power and the like as items of the measurement conditions.

Each calibration result in the plurality of calibration results in the calibration data is associated with the calibration condition corresponding to the time at which the calibration result was acquired.

The calibration data may be stored in advance in the calibration data manager 17 by user input operations to the input interface 14. Alternatively, the calibration data may be stored in advance in the calibration data manager 17 by being acquired from another apparatus via the communication interface 15.

The traceability determiner 18 includes at least one processor, at least one dedicated circuit, or a combination thereof. The processor may, for example, be a general-purpose processor, such as a central processing unit (CPU) or graphics processing unit (GPU), or a dedicated processor specialized for particular processing. The dedicated circuit is, for example, a field-programmable gate array (FPGA) or an application specific integrated circuit (ASIC).

The traceability determiner 18 reads programs, data, and the like stored in the memory 12 and executes various functions.

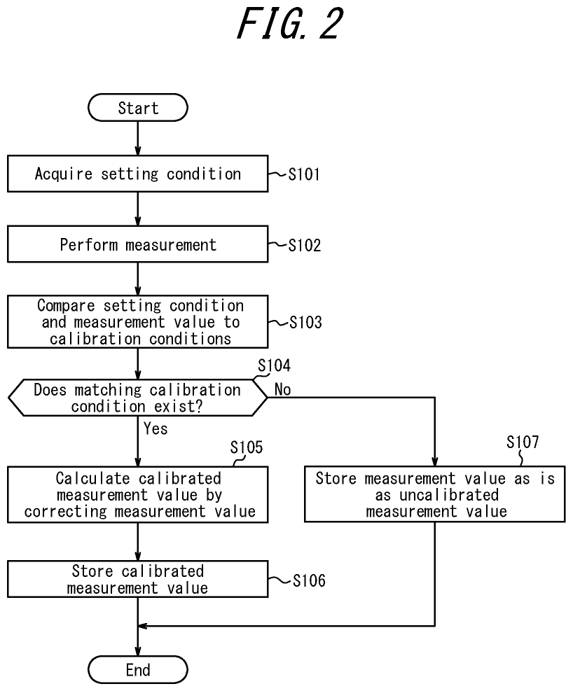

Operations of the measuring instrument with built-in calibration data 10 are described with reference to the flowchart illustrated in FIG. 2.

Step S101: the input interface 14 acquires, by user operation, the setting conditions of the measuring instrument with built-in calibration data 10 when performing measurement. The traceability determiner 18 stores the setting conditions acquired by the input interface 14 in the setting data manager 16. The sensor 11 is set to the setting conditions stored in the setting data manager 16.

Step S102: the user executes the measurement according to the configuration conditions set by step S101. For example, in a case in which the measuring instrument with built-in calibration data 10 is an optical power meter, the user measures optical power using the measuring instrument with built-in calibration data 10. When the measurement is executed by the user, the sensor 11 acquires a measurement value.

Step S103: the traceability determiner 18 compares the setting conditions acquired in step S101 and the measurement value acquired in step S102 to the plurality of calibration conditions included in the calibration data stored in the calibration data manager 17. For example, in a case in which the measuring instrument with built-in calibration data 10 is an optical power meter, the traceability determiner 18 compares the wavelength in the setting conditions acquired in step S101 with the wavelength in the setting conditions included in the calibration conditions, and compares the input power of the measurement value acquired in step S102 with the input power of the measurement conditions included in the calibration conditions.

Step S104: in a case in which there exists a matching calibration condition that matches the setting conditions and the measurement value (Yes in step S104), the traceability determiner 18 proceeds to step S105. In a case in which no calibration condition that matches the setting conditions and the measurement value exists (No in step S104), the traceability determiner 18 proceeds to step S107.

Step S105: in the case of a determination of Yes in step S104, the traceability determiner 18 calculates a calibrated measurement value by correcting the measurement value measured by the sensor 11 with the calibration result, among the plurality of calibration results included in the calibration data, that is associated with the calibration conditions matching the setting conditions. In the present embodiment, the “calibrated measurement value” refers to a measurement value corrected by a calibration result.

Step S106: the traceability determiner 18 stores the calibrated measurement value in the memory 12. The traceability determiner 18 may display the calibrated measurement value on the display 13. At this time, the traceability determiner 18 may display, on the display 13, the calibrated measurement value together with a notation indicating that the calibrated measurement value displayed on the display 13 is a traceable value. The notation indicating that the value is traceable may, for example, be letters such as “traceable” or a symbol indicating that the value is traceable. With this configuration, the user can confirm that the value displayed on the display 13 is a traceable value.

When storing the calibrated measurement value in the memory 12, the traceability determiner 18 may store, together with the calibrated measurement value, information indicating that the stored value is a calibrated measurement value, i.e., a measurement value that has been corrected by a calibration result.

Step S107: in the case of a determination of No in step S104, the traceability determiner 18 stores the measurement value measured by the sensor 11 as is in the memory 12 as an uncalibrated measurement value. The traceability determiner 18 may display the uncalibrated measurement value on the display 13. At this time, the traceability determiner 18 may display, on the display 13, the uncalibrated measurement value together with a notation indicating that the uncalibrated measurement value displayed on the display 13 is not a calibrated value. With this configuration, the user can confirm that the value displayed on the display 13 is not a traceable value.

When storing the uncalibrated measurement value as is in the memory 12, the traceability determiner 18 may store information indicating that the stored value is an uncalibrated measurement value, i.e., a value that has not been calibrated, together with the uncalibrated measurement value.

According to the above measuring instrument with built-in calibration data 10 in an embodiment, the calibration of measurement values can be facilitated. More specifically, the measuring instrument with built-in calibration data 10 includes the calibration data manager 17 that stores calibration data of the measuring instrument with built-in calibration data 10. Calibration data is thus stored inside the measuring instrument with built-in calibration data 10. The traceability determiner 18 of the measuring instrument with built-in calibration data 10 compares the setting condition and the measurement value to the plurality of calibration conditions. In a case in which there exists a calibration condition that matches the setting condition, the traceability determiner 18 calculates a calibrated measurement value by correcting the measurement value with the calibration result associated with the calibration condition. The traceability determiner 18 stores the calculated calibrated measurement value in the memory 12. The measuring instrument with built-in calibration data 10 according to an embodiment can thus automatically correct the measurement value and calculate the calibrated measurement value using the appropriate calibration result in the calibration data stored inside the measuring instrument with built-in calibration data 10. The measuring instrument with built-in calibration data 10 according to an embodiment can thereby reduce the burden on the user in correcting measurement values with calibration results and can facilitate the calibration of measurement values.

### (Recommended Calibration Period)

Usually, a recommended calibration period is set for traceable measuring instruments. The measuring instrument with built-in calibration data 10 may display, on the display 13, content that takes into account the recommended calibration period. Operations of the measuring instrument with built-in calibration data 10 in this case are described below.

The calibration data stored in the calibration data manager 17 further includes information on the date and time at which the calibration results were acquired.

The traceability determiner 18 compares the current date and time with the date and time yielded by adding the recommended calibration period to the date and time at which the calibration results were acquired. Information on the recommended calibration period may be stored in the memory 12.

In a case in which the current date and time exceeds the date and time yielded by adding the recommended calibration period to the date and time at which the calibration results were acquired, the traceability determiner 18 may display an alarm on the display 13. With this configuration, the user can recognize that the calibration data stored by the calibration data manager 17 is beyond the recommended calibration period and that new calibration data needs to be stored in the calibration data manager 17. In addition, with this configuration, the measuring instrument with built-in calibration data 10 can prevent the user from using a measurement value calibrated by a calibration result beyond the recommended calibration period as a traceable value.

In a case in which the current date and time exceeds the date and time yielded by adding the recommended calibration period to the date and time at which the calibration result was acquired, the traceability determiner 18 may be configured not to display, on the display 13, the notation indicating that the calibrated measurement value is a traceable value even in a case in which the calibrated measurement value is calculated. With this configuration, the measuring instrument with built-in calibration data 10 can prevent the user from using a measurement value calibrated by a calibration result beyond the recommended calibration period as a traceable value.

(Compliance with National Standards of a Plurality of Countries)

The calibration data manager 17 may store a plurality of sets of calibration data linked to national standards of a plurality of countries. Operations of the measuring instrument with built-in calibration data 10 in this case are described below.

The input interface 14 accepts a selection operation by the user as to which calibration data to use among the plurality of sets of calibration data associated with national standards of a plurality of countries and stored in the calibration data manager 17.

The traceability determiner 18 calculates the calibrated measurement value using the calibration data selected by the user. In other words, the measuring instrument with built-in calibration data 10 executes the process of the flowchart illustrated in FIG. 2 using the calibration data selected by the user.

In a case in which the user selects calibration data associated with a Japanese national standard, for example, the measuring instrument with built-in calibration data 10 can thereby perform measurements traceable to the Japanese national standard. In a case in which the user selects calibration data associated with an American national standard, for example, the measuring instrument with built-in calibration data 10 can perform measurements traceable to the American national standard.

### Comparative Example

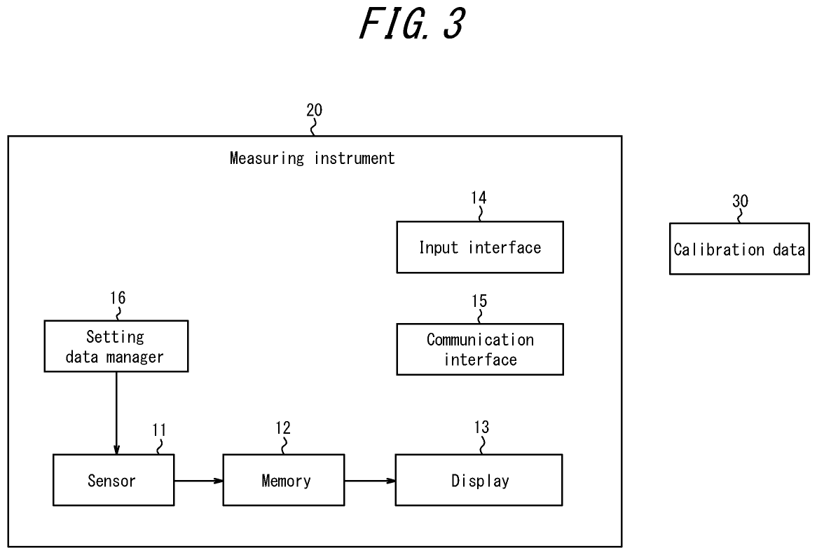

FIG. 3 is a diagram illustrating a schematic configuration of a measuring instrument 20 according to a comparative example.

The measuring instrument 20 according to the comparative example includes a sensor 11, a memory 12, a display 13, an input interface 14, a communication interface 15, and a setting data manager 16.

The measuring instrument 20 according to the comparative example differs from the measuring instrument with built-in calibration data 10 according to the embodiment illustrated in FIG. 1 by not including the calibration data manager 17 and the traceability determiner 18.

The measuring instrument 20 according to the comparative example does not include calibration data inside the measuring instrument 20. Therefore, the measuring instrument 20 according to the comparative example cannot automatically calibrate the measurement values.

In the case of calibrating measurement values measured by the measuring instrument 20 according to the comparative example, the user calculates the calibrated measurement value using calibration data 30.

The calibration data 30 is data for using a higher-level standard of the measuring instrument 20 to calibrate the measurement values measured by the measuring instrument 20. The calibration data 30 is data that is not stored in the measuring instrument 20, but rather is external to the measuring instrument 20. The calibration data 30 may be data printed on paper or stored in a computer.

In the case of using the measuring instrument 20 according to the comparative example, the user needs to refer to the calibration data 30 and manually correct the measurement values measured by the measuring instrument 20 in order to correct the measurement values using the calibration data 30.

By contrast, the measuring instrument with built-in calibration data 10 according to the embodiment illustrated in FIG. 1 can use the calibration data to automatically correct the measurement values measured by the measuring instrument with built-in calibration data 10. The burden on the user can thereby be reduced.

It will be clear to a person of ordinary skill in the art that the present disclosure may be implemented in certain ways other than the above embodiments without departing from the spirit or essential features thereof. Accordingly, the above explanation merely provides examples that are in no way limiting. The scope of the present disclosure is to be defined by the appended claims, not by the above explanation. Among all changes, various changes that are within the range of equivalents are included therein.

For example, the arrangement, number, and the like of the above-described components are not limited to the above explanation or the drawings. The arrangement, number, and the like of each component may be selected freely as long as the functions of the component can be achieved.

For example, in the above embodiment, the memory 12, the setting data manager 16, and the calibration data manager 17 are illustrated as separate components, but these three may be integrated into a single memory, or two of these three may be integrated into a single memory.

For example, in the above embodiment, wavelength and measurement range are provided as examples of items in the setting conditions in the case of the measuring instrument 20 being an optical power meter, but the items in the setting conditions may further include averaging time and the like.

1. A measuring instrument with built-in calibration data capable of traceable measurement, comprising:
a sensor;
a calibration data manager configured to store calibration data of the measuring instrument with built-in calibration data;
a setting data manager configured to store a setting condition of the measuring instrument with built-in calibration data;
a memory capable of storing a measurement value measured by the sensor; and
a traceability determiner, wherein
the calibration data includes a plurality of calibration results and a plurality of calibration conditions, the calibration results indicating a difference in measurement results from a higher-level standard,
each calibration result is associated with the calibration condition corresponding to a time at which the calibration result was acquired, and
the traceability determiner is configured to
compare the setting condition and the measurement value to the plurality of calibration conditions,
in a case in which there exists a matching calibration condition, among the plurality of calibration conditions, that matches the setting condition and the measurement value, calculate a calibrated measurement value by correcting the measurement value with the calibration result associated with the matching calibration condition, and
store the calibrated measurement value in the memory.

2. The measuring instrument with built-in calibration data according to claim 1, wherein in a case in which no calibration condition matches the setting condition and the measurement value, the traceability determiner is configured to store the measurement value measured by the sensor as is in the memory as an uncalibrated measurement value.

3. The measuring instrument with built-in calibration data according to claim 2, further comprising a display, wherein
the traceability determiner is configured to display, on the display, the calibrated measurement value or the uncalibrated measurement value.

4. The measuring instrument with built-in calibration data according to claim 3, wherein in a case in which the calibrated measurement value is calculated, the traceability determiner is configured to display, on the display, the calibrated measurement value together with a notation indicating that the calibrated measurement value is a traceable value.

5. The measuring instrument with built-in calibration data according to claim 4, wherein
the calibration data further includes information on a date and time at which the plurality of calibration results was acquired, and
in a case in which a current date and time exceeds a date and time yielded by adding a recommended calibration period to the date and time at which the plurality of calibration results was acquired, the traceability determiner is configured to display an alarm on the display.

6. The measuring instrument with built-in calibration data according to claim 4, wherein
the calibration data further includes information on a date and time at which the plurality of calibration results was acquired, and
in a case in which a current date and time exceeds a date and time yielded by adding a recommended calibration period to the date and time at which the plurality of calibration results was acquired, the traceability determiner is configured to refrain from displaying, on the display, the notation indicating that the calibrated measurement value is a traceable value even in a case in which the calibrated measurement value is calculated.

7. The measuring instrument with built-in calibration data according to claim 1, wherein
the calibration data manager is configured to store a plurality of sets of calibration data linked to national standards of a plurality of countries, and
the traceability determiner is configured to calculate the calibrated measurement value using calibration data selected by a user from among the plurality of sets of calibration data.

8. The measuring instrument with built-in calibration data according to claim 1, wherein the measuring instrument with built-in calibration data is an optical power meter.

9. The measuring instrument with built-in calibration data according to claim 8, wherein the setting condition and the calibration condition include a wavelength of light as an item.
